(19) United States
(12) Patent Application Publication
(10) Pub. No.: US 2013/0219448 A1
(43) Pub. Date: Aug. 22, 2013

(54) DIGITAL CABLE TELEVISION SYSTEM AND METHOD FOR DATA INTERACTION VIA WIRELESS TERMINAL

(71) Applicants: Ming Yuan, Shenzhen (CN); Rui Yi, Shenzhen (CN); Fengxi Liu, Fengxi (CN)

(72) Inventors: Ming Yuan, Shenzhen (CN); Rui Yi, Shenzhen (CN); Fengxi Liu, Fengxi (CN)

(73) Assignee: SHENZHEN COSHIP SOFTWARE ELECTRONICS CO., LTD., Shenzhen, Guangdong (CN)

(21) Appl. No.: 13/880,715

(22) PCT Filed: Feb. 28, 2011
(86) PCT No.: PCT/CN2011/071398

§ 371 Date: Apr. 19, 2013

(30) Foreign Application Priority Data
Oct. 20, 2010 (CN) 201010515099.0

(51) Int. Cl. H04N 21/61

(52) U.S. Cl. CPC H04N 21/6156
USPC 725/123

(57) ABSTRACT

A digital cable television system for data interaction via wireless terminal, includes a digital television reception terminal, a wireless transceiving module, a wireless terminal and a server, the wireless transceiving module is built-in or externally located to the digital television reception terminal, and physically connected with the digital television reception terminal. The wireless transceiving module is wirelessly connected to the wireless terminal, the wireless terminal is connected to the server via wireless network; the server is connected to the digital television reception terminal through cable television network. The present invention also provides a method for data interaction via wireless terminal.

This application claims the benefit of priority of CHINA patent application number 201010515099.0, filed, Oct. 20, 2010, entitled DIGITAL CABLE TELEVISION SYSTEM AND METHOD FOR DATA INTERACTION VIA WIRELESS TERMINAL, the contents of which are incorporated herein by reference in their entirety.

### FIELD OF THE INVENTION

The present invention relates to digital television field, and more particularly, to digital cable television system and method for data interaction via wireless terminal.

### BACKGROUND OF THE INVENTION

The existing digital television reception terminal can achieve two-way service interaction directly through bidirectional networks (such as Cable, Eoc, LAN). However, based on the actual situation in China, most of the regions have been deployed unilateral networks, so that if the service interaction is realized based on the bidirectional networks, it is inevitably to reconstruct and redeploy the existing unilateral networks. This means that a lot of manpower and material resource must be invested, which can result in a huge waste.

### SUMMARY OF THE INVENTION

The present invention provides a digital cable television system for data interaction via wireless terminal, the system can allow the users to enjoy on-demand, time-shift, application downloads, online games and other services, and can reduce the costs of the cable operators that the unidirectional digital cable television networks are transformed into bidirectional digital cable television networks.

The present invention further provides a data interaction method via wireless terminal, the method enables the digital television reception terminal and the server to achieve bidirectional interaction effect by means of unidirectional digital cable television network.

The technical solution of the present invention is accomplished by:

The present invention provides a digital cable television system for data interaction via wireless terminal, the digital cable television system, includes:
a digital television reception terminal, receiving data from a server through cable television network and processing the data, and exchanging data with a wireless transceiving module to achieve data interaction;
a wireless transceiving module, exchanging data with the digital television reception terminal to achieve data interaction through physical connection, and exchanging data with a wireless terminal to achieve data interaction through wireless connection;
a wireless terminal, exchanging data with the server to achieve data interaction through wireless network, and exchanging data with the wireless transceiving module to achieve data interaction through wireless connection; and
a server, receiving service request from the wireless terminal and processing the service request, and transmitting the requested data to the digital television reception terminal through the cable television network.

The server is further capable of transmitting processing results to the wireless terminal after processing the service request.

The wireless transceiving module is built-in or externally mounted to the digital television reception terminal.

The wireless terminal at least includes two communication modules, one of the communication modules is capable of exchanging data with the wireless transceiving module to achieve data interaction, and the other is capable of exchanging data with the server to achieve data interaction.

The wireless network at least includes CDMA 2000, CDMA1x, GSM, GPRS, EDGE, WCDMA, TD-SCDMA, LTE, TD-LTE, WiFi, WiMax and WAPI.

The wireless connection at least includes WiFi, Bluetooth, 2.4G, wireless HDMI, Z-WAVE, Zigbee, wireless USB and WAPI.

The interfaces of the physical connection at least include USB, RJ45, RS232, SDIO, serial bus and parallel bus.

The physical connection includes built-in connection or external connection.

The present invention further provides a data interaction method via wireless terminal, the data interaction method includes:

receiving service information from a server by a digital television reception terminal;

selecting the service information;

transmitting service request to a wireless terminal through a wireless transceiving module by the digital television reception terminal; and

transmitting the service request received from the wireless transceiving module to the server by the wireless terminal.

The method further includes processing the service information from the server by the digital television reception terminal.

The method further includes exchanging data with the wireless terminal to perform once or several times data interactions through the wireless transceiving module by the digital television reception terminal.

The method further includes processing the received service request by the wireless terminal.

The method further includes feeding processing results back to the wireless terminal by the server after processing the service request.

The method further includes a step of: pushing service data to the digital television reception terminal by the server after the step of transmitting the service request received from the wireless transceiving module to the server by the wireless terminal.

The technical effect of the present invention is: the present invention provides a digital cable television system for data interaction via wireless terminal, the digital television reception terminal can exchange data with the wireless terminal to achieve data interaction by means of setting the wireless transceiving module to the digital television reception terminal, further enabling to achieve bidirectional access functionality between the server and the unidirectional digital television reception terminal, so that users can enjoy on-demand, time-shift, application downloads, online games and other services, and the cable operators can reduce the costs that the unidirectional digital cable television networks are transformed into bidirectional digital cable television networks. The present invention also provides a method of data interaction via wireless terminal, the method is carried on and realized based on the interaction between the wireless terminal and the digital television reception terminal and the transmission of data over the wireless network, enabling to achieve bidirectional interaction effect between the digital television reception terminal and the server through the unidirectional digital cable television network.

### BRIEF DESCRIPTION OF THE DRAWINGS

FIG. 1 is a structural diagram of a digital television receiving system for data interaction via wireless terminal according to an embodiment of the present invention;

FIG. 2 is a flow diagram of the steps in a data interaction method via wireless terminal according to an embodiment of the present invention.

### DETAILED DESCRIPTION OF ILLUSTRATED EMBODIMENTS

To make the objects and advantages of the present invention more clearly, the following drawings in conjunction with the accompanying embodiments are used here for detailed description to this present invention.

In the introduction of embodiments before, it is necessary to describe the services of digital television in brief, the services of the digital television include digital television, digital radio, on-demand, time-shift, music, video broadcasting, audio broadcasting, games, voting, stock, advertising, news, shopping, education, medical services, picture browsing, web browsing and so on.

Service data includes service information and entity data of the service information.

The service information means service description for the user to select, such as name, size, channel information, program guide, time, tips, comments, copyright information, prices, menus, web pages, web pages, portals and other information.

Service request includes control instructions and attachment information of the control instructions.

The interaction means reception and transmission of information, commands, or mutual transfer of commands, instructions or data between two devices or terminals.

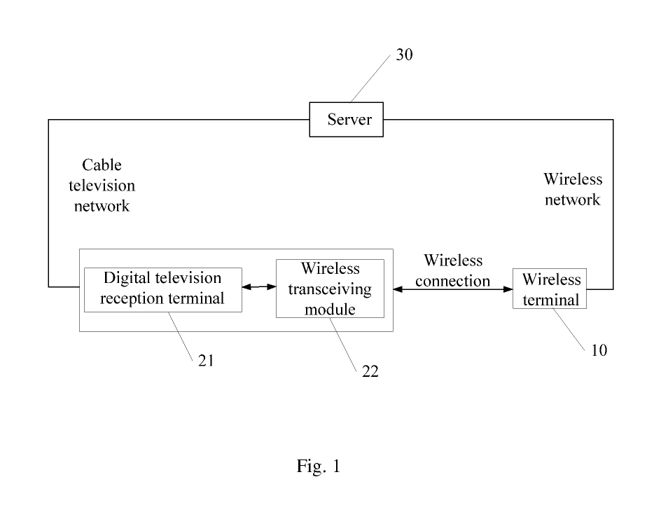

Referring to FIG. 1, the present invention provides a digital television receiving system for data interaction via wireless terminal, which includes a digital television reception terminal 21, a wireless transceiving module 22, a wireless terminal 10 and a server 30. The wireless transceiving module 22 can be built-in or externally mounted to the digital television reception terminal 21, and be physically connected to the digital television reception terminal 21. The wireless transceiving module 22 is wirelessly connected to the wireless terminal 10, and the wireless terminal 10 is connected to the server 30 through wireless network, and the server 30 is connected to the digital television reception terminal 21 through cable television network. Wherein,
the digital television reception terminal 21 can receive data from the server through the cable television network and process the data, and can exchange data with the wireless transceiving module to achieve data interaction.

The wireless transceiving module 22 exchanges data with the digital television reception terminal to accomplish data interaction through physical connection, and exchanges data with the wireless terminal to achieve data interaction through wireless connection. The interfaces of the physical connection at least include USB (Universal Serial BUS), RJ45 (usually used for data transmission, and most used as network interface card), RS232 (asynchronous transmission standard interface developed by the Electronic Industries Association), SDIO (Secure Digital Input and Output Card), serial bus, parallel bus. At the same time, the physical connection can be built-in connection or external connection. The wireless connection here can refer to one of more of WiFi (Wireless Fidelity), Bluetooth, 2.4G (2.4-Generation), wireless HDMI (High Definition Multimedia Interface), Z-WAVE (a short-range wireless networking communication technology), Zigbee (another low-power and short-range wireless networking communication technology), wireless USB and WAPI (Wireless LAN Authentication and Privacy Infrastructure), of course, the wireless connection here can also be other wireless connections.

The wireless terminal 10 exchanges data with the server to accomplish data interaction through wireless network, and exchanges data with the wireless transceiving module to achieve data interaction through wireless connection. The wireless network can be one or more of CDMA (Code Division Multiple Access) 2000 (one of 3G mobile communication standards), CDMA1x (the first phase of CDMA2000), GSM (Global System for Mobile Communications), GPRS (General Packet Radio Service), EDGE (Enhanced Data Rate for GSM Evolution), WCDMA (Wideband Code Division Multiple Access), TD-SCDMA (Time Division-Synchronous Code Division Multiple Access), LTE (Long Term Evolution), TD-LTE (TD-SCDMA Long Term Evolution), WiFi, WiMax (Worldwide Interoperability for Microwave Access) and WAPI, of course, or other wireless networks. The wireless terminal at least includes two communication modules, one of the communication modules is capable of exchanging data with the wireless transceiving module to achieve data interaction, and the other is capable of exchanging data with the server to achieve data interaction.

The server 30 receives service request from the wireless terminal, and processes the service request, and transmits the requested data to the digital television reception terminal through the cable television network. The server further includes a feedback module which can feed back processing results to the wireless terminal after processing the service request, so that the server can also feed back results to the wireless terminal.

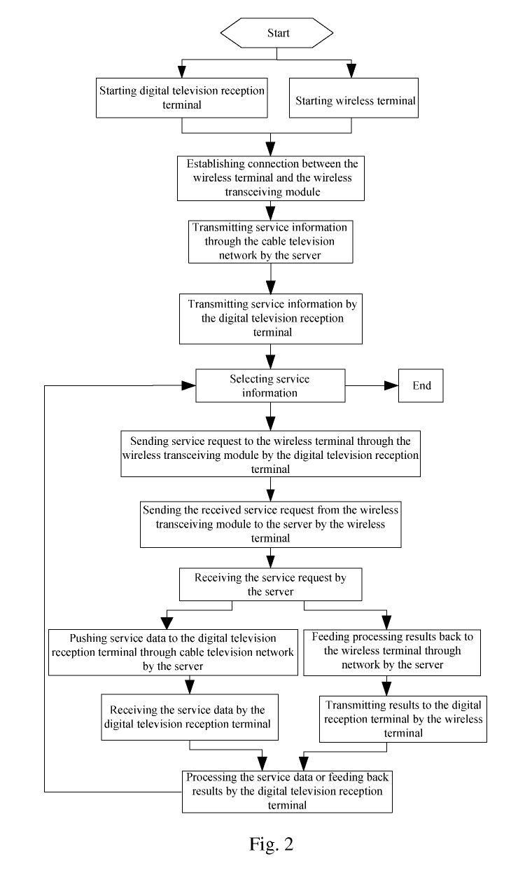

Referring to FIG. 2, the FIG. 2 is a flow diagram of a data interaction method via wireless terminal according to an embodiment of the present invention, and the data interaction method as shown in FIG. 2 mainly includes the following steps:
starting the system;
starting the digital television reception terminal and the wireless transceiving module;
starting the wireless terminal at the same time or immediately;
establishing connection between the wireless terminal and the wireless transceiving module while the wireless terminal being started, wherein the connection here can be wireless connection, or can be other possible connections of course;
transmitting service information to the digital television reception terminal through the cable television network by the server;
the digital television reception terminal being able to process the service information sent by the server;
receiving the service information from the server by the digital television reception terminal;
viewing the service information and selecting the desired target service information in the service information;
transmitting the service request to the wireless terminal through the wireless transceiving module by the digital television reception terminal;
processing the received service request by the wireless terminal;

Transmitting the received service request from the wireless transceiving module to the server by the wireless terminal;
receiving the service request from the wireless terminal through the wireless network and processing the service request by the server;
pushing service data to the digital television reception terminal through the cable television network according to the result of processing the service request by the server;
receiving the service data by the digital television reception terminal;
processing the service data by the digital television reception terminal.

After the step of receiving the service request from the wireless terminal through wireless network and processing the service request by the server, feeding processing information or processing results back to the wireless terminal; it should be understood that the feedback action can be carried out or may not be performed;
transmitting the feedback information to the digital television reception terminal after the wireless terminal receiving the feedback information, the feedback action can be carried out or may not be performed;
processing or displaying the feedback information by the digital television reception terminal.

In the above steps, the digital television reception terminal can exchange data with the wireless terminal through the wireless transceiving module to perform once or several times data interactions.

Although the present disclosure has been specifically described on the basis of the exemplary embodiment thereof, the disclosure is not to be construed as being limited thereto. Any change or modification may be made to the embodiment without departing from the scope or spirit of the disclosure.

1. A digital cable television system for data interaction via wireless terminal, comprising:
a digital television reception terminal, receiving data from a server through cable television network and processing the data, and exchanging data with a wireless transceiving module to achieve data interaction;
a wireless transceiving module, exchanging data with the digital television reception terminal to achieve data interaction through physical connection, and exchanging data with a wireless terminal to achieve data interaction through wireless connection;
a wireless terminal, exchanging data with the server to achieve data interaction through wireless network, and exchanging data with the wireless transceiving module to achieve data interaction through wireless connection; and
a server, receiving service request from the wireless terminal, and processing the service request, and transmitting the requested data to the digital television reception terminal through the cable television network.

2. The system as claimed in claim 1, wherein the server is further capable of transmitting processing results to the wireless terminal after processing the service request.

3. The system as claimed in claim 1, wherein the wireless transceiving module is built-in or externally mounted to the digital television reception terminal.

4. The system as claimed in claim 1, wherein the wireless terminal at least comprises two communication modules, one of the communication modules is capable of exchanging data with the wireless transceiving module to achieve data interaction, and the other is capable of exchanging data with the server to achieve data interaction.

5. The system as claimed in claim 1, wherein the wireless network at least comprises CDMA 2000, CDMA1x, GSM, GPRS, EDGE, WCDMA, TD-SCDMA, LTE, TD-LTE, WiFi, WiMax and WAPI.

6. The system as claimed in claim 1, wherein the wireless connection at least comprises WiFi, Bluetooth, 2.4G, wireless HDMI, Z-WAVE, Zigbee, wireless USB and WAPI.

7. The system as claimed in claim 1, wherein the interfaces of the physical connection at least comprise USB, RJ45, RS232, SDIO, serial bus and parallel bus.

8. The system as claimed in claim 7, wherein the physical connection comprises built-in connection or external connection.

9. A method of data interaction via wireless terminal, comprising:
receiving service information from a server by a digital television reception terminal;
selecting the service information;
transmitting service request to a wireless terminal through a wireless transceiving module by the digital television reception terminal; and
transmitting the service request received from the wireless transceiving module to the server by the wireless terminal.

10. The method as claimed in claim 9, further comprising processing the service information from the server by the digital television reception terminal.

11. The method as claimed in claim 9, further comprising exchanging data with the wireless terminal to perform once or several times data interactions through the wireless transceiving module by the digital television reception terminal.

12. The method as claimed in claim 9, further comprising processing the received service request by the wireless terminal.

13. The method as claimed in claim 9, further comprising feeding processing results back to the wireless terminal by the server after processing the service request.

14. The method as claimed in claim 9, further comprising a step of:
pushing service data to the digital television reception terminal by the server after the step of transmitting the service request received from the wireless transceiving module to the server by the wireless terminal.
